(19) United States
(12) Patent Application Publication
(10) Pub. No.: US 2026/0255243 A1
(43) Pub. Date: Aug. 27, 2026

(54) ENHANCED HANDOVER PROCEDURE FOR SUPPORTING NETWORK ENERGY SAVING

(71) Applicant: GOOGLE LLC, Mountain View, CA (US)

(72) Inventors: Ming-Hung Tao, Taoyuan City (TW); Chih-Hsiang Wu, Taoyuan City (TW)

(21) Appl. No.: 19/473,057

(22) PCT Filed: Apr. 8, 2024
(86) PCT No.: PCT/US2024/023633

§ 371 Date: Oct. 6, 2025

Related U.S. Application Data
(60) Provisional application No. 63/494,770, filed on Apr. 6, 2023.

(51) Int. Cl. H04W 36/16; H04W 24/08; H04W 36/36

(52) U.S. Cl. CPC H04W 36/165; H04W 24/08; H04W 36/362

(57) ABSTRACT

A user equipment receives (509), from a radio access network (RAN) in a serving cell, a measurement configuration for a candidate cell. The UE receives (520), subsequently to the receiving of the measurement configuration and when the measurement configuration is deactivated, an indication of a non-active period in the serving cell. In response to the indication of the non-active period, the UE activates (535 A) the measurement configuration for the candidate cell.

### CROSS-REFERENCE TO RELATED APPLICATION

This application claims priority to and the benefit of the filing date of provisional U.S. Patent Application No. 63/494,770 entitled “ENHANCED HANDOVER PROCEDURE FOR SUPPORTING NETWORK ENERGY SAVING,” filed on Apr. 6, 2023. The entire content of the provisional application is hereby expressly incorporated herein by reference.

### FIELD OF THE DISCLOSURE

This disclosure relates generally to wireless communications and, more particularly, to enabling the network energy saving feature for a base station, and handing over the user equipment units (UEs) with stringent data latency requirements to another base station.

### BACKGROUND

This background description is provided for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

The objectives behind developing the fifth generation (5G) technology include providing a unified framework for such types of communication as enhanced mobile broadband (eMBB), ultra-reliable low-latency communications (URLLC), and massive machine type communication (mMTC).

Network energy saving is important for environmental sustainability, as it can reduce environmental impact (e.g., greenhouse gas emissions), and is beneficial for operational cost savings. As 5G technology develops to cover ever-increasing types of communications and territories, supporting more advanced services and applications requires high data rates. As a result, networks need to be deployed in a dense manner, using more antennas, larger bandwidths and more frequency bands. Network operators need to control the environmental impact of 5G, and develop advanced solutions for improving network energy savings.

Energy consumption has become an increasingly large component of operating expenses for mobile network operators. According to a report by the Global System for Mobile Communications Association (GSMA), the energy cost associated with mobile networks accounts for approximately 23% of the total operating cost. Most of the energy consumption comes from the radio access network, particularly the Active Antenna Unit (AAU), while the data centers and fiber transport account for a smaller portion of the cost. Two types of power consumption contribute to the overall power consumption of a radio access network: 1.) a dynamic part, which includes power that the network consumes during data transmission/reception; and 2.) a static part, which includes power that to maintain operation of the radio access network, even in absence of data transmission/reception.

During the Study Item (SI) phase of the Network Energy Saving (NES) work item (Release 18), 3GPP defined the network energy consumption model for the base station (BS), which includes the reference configurations for FR1 TDD/FDD and FR2. Based on the agreed BS energy consumption model, the evaluation methodology, and assumptions, the SI evaluated potential network energy saving techniques in various domains in terms of the energy saving gains and the corresponding performance impact. The SI classified those techniques into time, frequency, spatial and power domains, and the technical report 3GPP TR 38.864 summarized the technical descriptions as well as the impacts to legacy UEs and specifications. The techniques in time and frequency domains aim to reduce the power consumption by turning off some symbols/slots/frames on one or more carriers, allowing the BS to perform some level (e.g., micro/light/deep) of sleep, depending on the interval between the contiguous active transmission/reception occasions. The techniques in spatial and power domains aim to reduce the power consumption of the transceiver chains and power amplifiers (PA) by attempting to turn off a greater number of spatial elements, reduce transmission power, and/or increase the PA efficiency.

In these and other scenarios, network power saving techniques increase latency for connected UEs, UEs with stringent data latency requirements may not support some network power saving techniques. The BS should efficiently perform a handover of these and other UEs before the BS goes to sleep.

### SUMMARY

Generally speaking, the techniques of this disclosure allow a connected UE connecting to a cell enabling the NES feature to be handed over properly and efficiently to another cell in time.

An example embodiment provides a method in a user equipment (UE) comprising: receiving, from a radio access network (RAN) in a serving cell, a measurement configuration for a candidate cell; receiving, subsequently to the receiving of the measurement configuration and when the measurement configuration is deactivated, an indication of a non-active period in the serving cell; and in response to the indication of the non-active period, activating the measurement configuration for the candidate cell.

An example embodiment provides a method in a base station, the method comprising: transmitting, to a user equipment (UE) in a serving cell, a measurement configuration for a candidate cell, wherein the measurement configuration is deactivated for the UE; transmitting, subsequently to the transmitting of the measurement configuration, an indication of a non-active period in the serving cell; and subsequently to the transmitting of the indication of the non-active period, receiving, from the UE, a measurement report for the candidate cell.

Still another example embodiment of these techniques is an apparatus comprising a transceiver; and one or more processors and configured to implement the methods above.

### BRIEF DESCRIPTION OF THE DRAWINGS

FIG. 1A is a block diagram of an example wireless communication system in which a user device and a base station of this disclosure can implement the paging techniques of this disclosure;

FIG. 1B is a block diagram of an example base station in which a centralized unit (CU) and a distributed unit (DU) that can operate in the system of FIG. 1A;

FIG. 2A is a block diagram of an example protocol stack according to which the UE of FIG. 1A communicates with base stations;

FIG. 2B is a block diagram of an example protocol stack according to which the UE of FIG. 1A communicates with a CU and a DU;

FIG. 3A is a messaging diagram of an example demonstrating how a UE informs the network of its preference on supporting NES, and how a BS responds to it;

FIG. 3B is a messaging diagram of an example demonstrating how a UE informs the network of its preference on supporting NES, while being configured with the cell DTX/DRX configuration;

FIG. 4A is a messaging diagram of an example demonstrating how a UE in the connected state autonomously transmits its logged or periodic measurement report to the BS, upon being notified of an upcoming cell non-active period;

FIG. 4B is a messaging diagram of an example demonstrating how a UE in the connected state autonomously transmits its event-triggered measurement report to the BS, upon being notified of an upcoming cell non-active period;

FIG. 4C is a messaging diagram of an example demonstrating how a UE in the connected state autonomously transmits its event-triggered measurement report to the BS, prior to the arrival of a regular cell non-active period;

FIG. 5A is a messaging diagram of an example demonstrating how a UE in the connected state autonomously triggers the candidate cell evaluation for the conditional handover (CHO) execution, upon being notified of an upcoming cell non-active period;

FIG. 5B is a messaging diagram of an example demonstrating how a UE in the connected state selectively triggers the candidate cell evaluation for the CHO execution, upon being notified of an upcoming cell non-active period;

FIG. 5C is a messaging diagram of an example demonstrating how a UE in the connected state autonomously triggers the candidate cell evaluation for the conditional handover (CHO) execution, prior to the arrival of a regular cell non-active period;

FIG. 6 is a flow diagram of an example method that can be implemented by a UE in the connected state, for informing the BS of its status regarding whether it can support the cell DTX/DRX mode;

FIG. 7 is a flow diagram of an example method that can be implemented by a UE in the connected state, for transmitting its logged or periodic measurement report upon being informed of a cell non-active period;

FIG. 8 is a flow diagram of an example method that can be implemented by a UE in the connected state, for activating deactivated measurement identities upon being informed of a cell non-active period;

FIG. 9 is a flow diagram of an example method that can be implemented by a UE in the connected state, for activating deactivated measurement identities prior to the arrival of a pre-configured cell non-active period;

FIG. 10 is a flow diagram of an example method that can be implemented by a UE in the connected state, for activating deactivated CHO execution condition upon being informed of a cell non-active period;

FIG. 11 is a flow diagram of an example method that can be implemented by a UE in the connected state, for selectively activating deactivated CHO execution condition based on a list of neighbor cells provided by the BS;

FIG. 12 is a flow diagram of an example method that can be implemented by a UE in the connected state, for selectively activating deactivated CHO execution condition based on the DCI or DL MAC CE provided by the BS;

FIG. 13 is a flow diagram of an example method that can be implemented by a UE in the connected state, for activating deactivated CHO execution condition prior to the arrival of a pre-configured cell non-active period;.

FIG. 14 is a flow diagram of an example method that can be implemented by a BS, for determining whether to handover a UE based on UE's preference on supporting the NES feature;

FIG. 15 is a flow diagram of an example method that can be implemented by a BS, for receiving a logged or a periodic measurement report from a UE before starting a cell non-active period;

FIG. 16 is a flow diagram of an example method that can be implemented by a BS, for configuring a UE with one or multiples deactivated MeasId(s) that can be activated autonomously by the UE later;

FIG. 17 is a flow diagram of an example method that can be implemented by a BS, for configuring a UE with a CHO configuration including one or multiples deactivated CHO execution conditions that can be activated autonomously by the UE later;.

FIG. 18 is a flow diagram of an example method that can be implemented by a BS, for configuring a UE with a CHO configuration including one or multiples deactivated CHO execution conditions, which can be activated later based on a list of neighbor cells.; and

FIG. 19 is a flow diagram of an example method that can be implemented by a BS, for configuring a UE with a CHO configuration including one or multiples deactivated CHO execution conditions, which can be activated later based on a DCI or a DL MAC CE.

### DETAILED DESCRIPTION OF THE DRAWINGS

As discussed in more detail below, a user equipment (UE) and/or a network node of a radio access network (RAN) can use the techniques of this disclosure for managing early data communication and transitioning a UE between states of a protocol for controlling radio resources between the UE and the RAN.

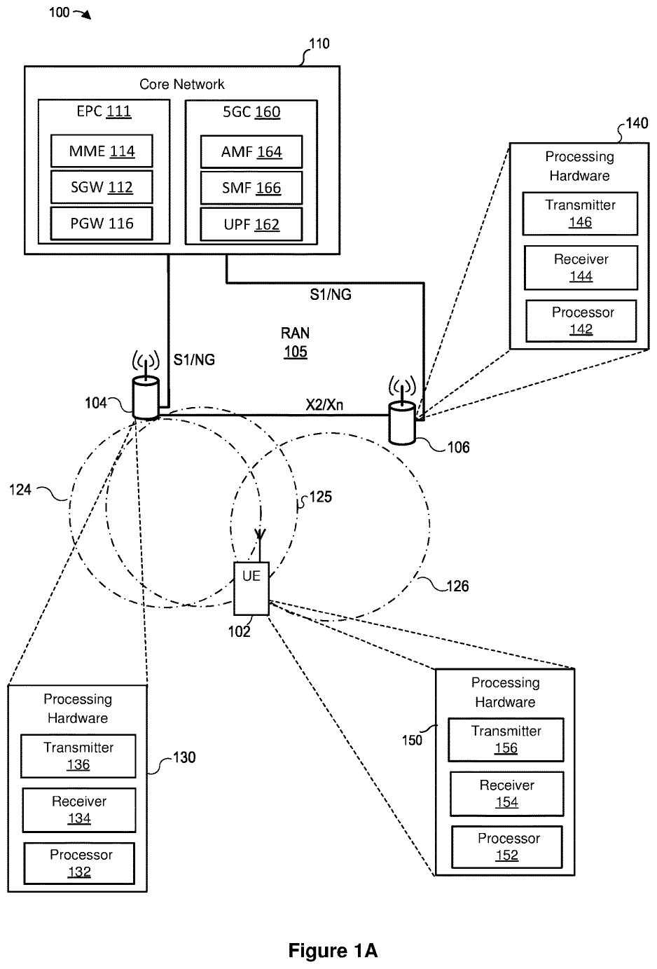

Referring first to FIG. 1A, an example wireless communication system 100 includes a UE 102, a base station (BS) 104, a base station 106, and a core network (CN) 110. The base stations 104 and 106 can operate in a RAN 105 connected to the core network (CN) 110. The CN 110 can be implemented as an evolved packet core (EPC) 111 or a fifth generation (5G) core (5GC) 160, for example. The CN 110 can also be implemented as a sixth generation (6G) core in another example.

The base station 104 covers a cell 124, and the base station 106 covers a cell 126. If the base station 104 is a gNB, the cell 124 is an NR cell. If the base station 104 is an ng-eNB or eNB, the cell 124 is an evolved universal terrestrial radio access (E-UTRA) cell. Similarly, if the base station 106 is a gNB, the cell 126 is an NR cell, and if the base station 106 is an ng-eNB or eNB, the cell 126 is an E-UTRA cell. The cells 124 and 126 can be in the same Radio Access Network Notification Areas (RNA) or different RNAs. In general, the RAN 105 can include any number of base stations, and each of the base stations can cover one, two, three, or any other suitable number of cells. The UE 102 can support at least a 5G NR (or simply, “NR”) or E-UTRA air interface to communicate with the base stations 104 and 106. Each of the base stations 104, 106 can connect to the CN 110 via an interface (e.g., S1 or NG interface). The base stations 104 and 106 also can be interconnected via an interface (e.g., X2 or Xn interface) for interconnecting NG RAN nodes.

Among other components, the EPC 111 can include a Serving Gateway (SGW) 112, a Mobility Management Entity (MME) 114, and a Packet Data Network Gateway (PGW) 116. The SGW 112 in general is configured to transfer user-plane packets related to audio calls, video calls, Internet traffic, etc., and the MME 114 is configured to manage authentication, registration, paging, and other related functions. The PGW 116 provides connectivity from the UE to one or more external packet data networks, e.g., an Internet network and/or an Internet Protocol (IP) Multimedia Subsystem (IMS) network. The 5GC 160 includes a User Plane Function (UPF) 162 and an Access and Mobility Management Function (AMF) 164, and/or Session Management Function (SMF) 166. Generally speaking, the UPF 162 is configured to transfer user-plane packets related to audio calls, video calls, Internet traffic, etc., the AMF 164 is configured to manage authentication, registration, paging, and other related functions, and the SMF 166 is configured to manage PDU sessions.

As illustrated in FIG. 1A, the base station 104 supports a cell 124, and the base station 106 supports a cell 126. The cells 124 and 126 can partially overlap, so that the UE 102 can select, reselect, or hand over from one of the cells 124 and 126 to the other. To directly exchange messages or information, the base station 104 and base station 106 can support an X2 or Xn interface. In general, the CN 110 can connect to any suitable number of base stations supporting NR cells and/or EUTRA cells.

As discussed in detail below, the UE 102 and/or the RAN 105 implement the techniques of this disclosure when the radio connection between the UE 102 and the RAN 105 is suspended, e.g., in the inactive or idle state of the protocol for controlling radio resources between the UE 102 and the RAN 105. For clarity, the examples below refer to the RRC_INACTIVE or RRC_IDLE state of the RRC protocol.

The base station 104 is equipped with processing hardware 130 that can include one or more general-purpose processors (e.g., CPUs) and a non-transitory computer-readable memory storing instructions that the one or more general-purpose processors execute. Additionally or alternatively, the processing hardware 130 can include special-purpose processing units. The processing hardware 130 in an example implementation includes a processor 132 to process data that the base station 104 will transmit in the downlink direction, or process data received by the base station 104 in the uplink direction. The processing hardware 130 can also include a transmitter 136 configured to transmit data in the downlink direction. The processing hardware further can include a receiver 134 configured to receive data in the uplink direction. The base station 106 can include generally similar components. In particular, components 140, 142, 144, and 146 of the base station 106 can be similar to the components 130, 132, 134, and 136, respectively.

The UE 102 is equipped with processing hardware 150 that can include one or more general-purpose processors (e.g., CPUs) and non-transitory computer-readable memory storing machine-readable instructions executable on the one or more general-purpose processors, and/or special-purpose processing units. The processing hardware 150 in an example implementation includes a processor 152 to process data that the UE 102 will transmit in the uplink direction or receive in the downlink direction. The processing hardware 150 can also include a transmitter 156 configured to transmit data in the downlink direction. The processing hardware further can include a receiver 154 configured to receive data in the uplink direction.

FIG. 1B depicts an example distributed or disaggregated implementation of any one or more of the base stations 104, 106. In this implementation, the base station 104, 106 includes a central unit (CU) 172 and one or more distributed units (DUs) 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include a PDCP controller, an RRC controller and/or an RRC inactive controller. In some implementations, the CU 172 can include a radio link control (RLC) controller configured to manage or control one or more RLC operations or procedures. In further implementations, the CU 172 does not include an RLC controller.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a MAC controller (e.g., MAC controller 132, 142) configured to manage or control one or more MAC operations or procedures (e.g., a random access procedure), and/or an RLC controller configured to manage or control one or more RLC operations or procedures. The processing hardware can also include a physical layer controller configured to manage or control one or more physical layer operations or procedures.

In some embodiments, the RAN 105 supports Integrated Access and Backhaul (IAB) functionality. In some implementations, the DU 174 operates as an IAB-node, and the CU 172 operates as an IAB-donor. In some embodiments, the RAN 105 supports Non-Terrestrial Network (NTN) functionality.

In some implementations, the CU 172 can include a logical node CU-CP 172A that hosts the control plane part of the PDCP protocol of the CU 172. The CU 172 can also include logical node(s) CU-UP 172B that hosts the user plane part of the PDCP protocol and/or Service Data Adaptation Protocol (SDAP) protocol of the CU 172. The CU-CP 172A can transmit control information (e.g., RRC messages, F1 application protocol messages), and the CU-UP 172B can transmit the data packets (e.g., SDAP PDUs or Internet Protocol packets).

The CU-CP 172A can be connected to multiple CU-UP 172B through the El interface. The CU-CP 172A selects the appropriate CU-UP 172B for the requested services for the UE 102. In some implementations, a single CU-UP 172B can connect to multiple CU-CP 172A through the E1 interface. The CU-CP 172A can connect to one or more DU 174s through an F1-C interface.

The CU-UP 172B can connect to one or more DU 174 through the F1-U interface under the control of the same CU-CP 172A. In some implementations, one DU 174 can connect to multiple CU-UP 172B under the control of the same CU-CP 172A. In such implementations, the CU-CP 172A establishes the connectivity between a CU-UP 172B and a DU 174 using Bearer Context Management functions.

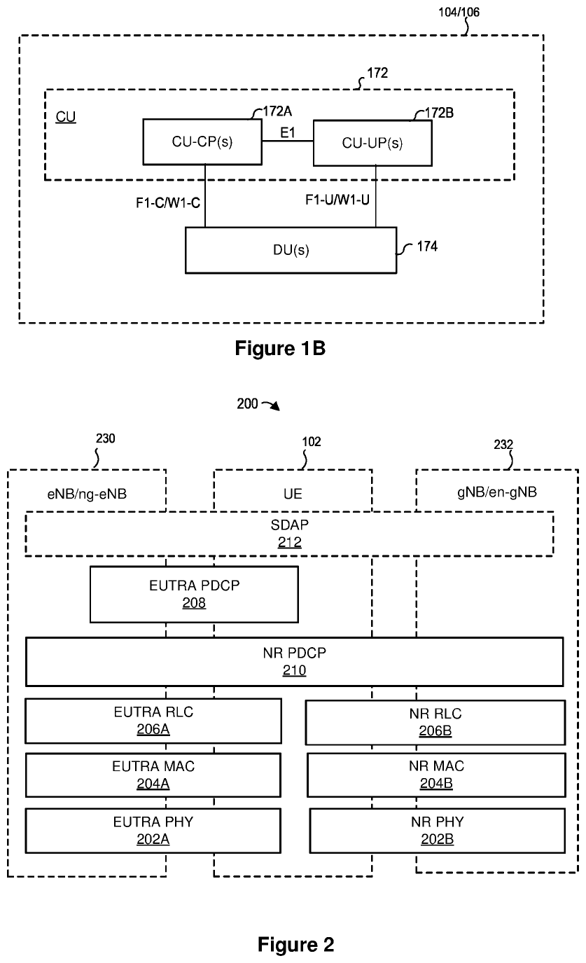

FIG. 2A illustrates, in a simplified manner, an example protocol stack 200 according to which the UE 102 can communicate with an eNB/ng-eNB or a gNB (e.g., one or more of the base stations 104, 106).

In the example stack 200, a physical layer (PHY) 202A of EUTRA provides transport channels to the EUTRA MAC sublayer 204A, which in turn provides logical channels to the EUTRA RLC sublayer 206A. The EUTRA RLC sublayer 206A in turn provides RLC channels to an EUTRA PDCP sublayer 208 and, in some cases, to an NR PDCP sublayer 210. Similarly, the NR PHY 202B provides transport channels to the NR MAC sublayer 204B, which in turn provides logical channels to the NR RLC sublayer 206B. The NR RLC sublayer 206B in turn provides data transfer services to the NR PDCP sublayer 210. The NR PDCP sublayer 210 in turn can provide data transfer services to Service Data Adaptation Protocol (SDAP) 212 or a radio resource control (RRC) sublayer (not shown in FIG. 2A). The UE 102, in some implementations, supports both the EUTRA and the NR stack as shown in FIG. 2A, to support handover between EUTRA and NR base stations and/or to support DC over EUTRA and NR interfaces. Further, as illustrated in FIG. 2A, the UE 102 can support layering of NR PDCP 210 over EUTRA RLC 206A, and SDAP sublayer 212 over the NR PDCP sublayer 210.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Except where the difference between SDUs and PDUs is relevant, this disclosure for simplicity refers to both SDUs and PDUs as “packets.” On a control plane, the EUTRA PDCP sublayer 208 and the NR PDCP sublayer 210 can provide signaling radio bearers (SRBs) or an RRC sublayer (not shown in FIG. 2A) to exchange RRC messages or non-access-stratum (NAS) messages, for example. On a user plane, the EUTRA PDCP sublayer 208 and the NR PDCP sublayer 210 can provide Data Radio Bearers (DRBs) to support data exchange. Data exchanged on the NR PDCP sublayer 210 can be SDAP PDUs, Internet Protocol (IP) packets or Ethernet packets.

FIG. 2B illustrates, in a simplified manner, an example protocol stack 250, which the UE 102 can communicate with a DU (e.g., DU 174) and a CU (e.g., CU 172). The radio protocol stack 200 is functionally split as shown by the radio protocol stack 250 in FIG. 2B. The CU at any of the base stations 104 or 106 can hold all the control and upper layer functionalities (e.g., RRC 214, SDAP 212, NR PDCP 210), while the lower layer operations (e.g., NR RLC 206B, NR MAC 204B, and NR PHY 202B) are delegated to the DU. To support connection to a 5GC, NR PDCP 210 provides SRBs to RRC 214, and NR PDCP 210 provides DRBs to SDAP 212 and SRBs to RRC 214.

The objectives of Network Energy Saving (NES) include specifying SSB-less SCell operation for inter-band CA for a first frequency range (FR1) and co-located cells, where a UE measures SSB transmitted on PCell or another SCell for time/frequency synchronization of an Scell (including downlink AGC), and L1/L3 measurements, including possible potential enhancement on Scell activation procedures. The objectives of NES can further include specifying enhancements for cell discontinuous transmission (DTX) or discontinuous reception (DRX) mechanisms including the alignment of cell DTX/DRX and UE DRX in an RRC_CONNECTED mode, and inter-node information exchange on cell DTX/DRX.

The objectives of NES can further include specifying techniques in spatial and power domains, including: 1.) specifying enhancements of CSI-and beam management-related procedures (including measurement/report, and signaling) to enable efficient adaptation of spatial elements (e.g., antenna ports, active transceiver chains); and 2.) specifying enhancements of CSI related procedures including measurement and report, and signaling to enable efficient adaptation of power offset values between PDSCH and CSI-RS.

Further, the objectives of NES can include specifying mechanism(s) to prevent legacy UEs camping on cells adopting the Rel-18 NES techniques. Other objectives include specifying CHO procedure enhancement(s) for cases in which a source/target cell is in NES mode, specifying inter-node beam activation and enhancements for restricting paging in a limited area, and specifying the corresponding RRM/RF core requirements for any of the objectives stated above.

Cell DTX/DRX applies to at least UEs in a connected state (e.g., RRC_CONNECTED). For the cell DTX/DRX configuration, a gNB can configure a periodic cell DTX/DRX (e.g., DTX/DDRX active and non-active periods) via UE-specific RRC signaling per serving cell. The cell DTX/DRX mode can additionally be activated/de-activated via dynamic L1/L2 signalling and UE-specific RRC signaling. Regarding the BS behaviors during the non-active (i.e., off) period in the cell DTX/DRX mode a BS may: 1.) turn off all transmission and reception for data traffic and reference signals during cell DTX/DRX non-active periods; 2.) turn off BS transmission/reception only for data traffic during Cell DTX/DRX non-active periods (i.e., BS will still transmit/receive reference signals); 3.) turn off BS dynamic data transmission/reception during Cell DTX/DRX non-active periods (i.e., BS is expected to still perform transmission/reception in periodic resources, including SPS, CG-PUSCH, SR, RACH, and SRS); or 4.) a only transmit reference signals (e.g., CSI-RS for measurement).

Example 1:
Example 2:
   Example 3:
Example 4:

If a BS operates according to the first possibility above, before the BS starts a cell non-active period, all connected UEs shall be handed over to another BS. If a BS operates according to the second possibility or the fourth possibility above, UEs that are actively transmitting/receiving data or have stringent data latency requirements may be handed over to another BS that does not enable time-domain energy saving technique. As different UEs may have different preferences for supporting network energy saving techniques (and the same UE may have different preferences at different times), the BS may be unable to determine which UEs that need to be handed over before the BS starts a non-active period offered by the energy saving technique.

In addition, as the BS may need to hand over a large number of UEs before starting a cell non-active period, signal optimization would needed to prevent signal congestion/loading from becoming unacceptably high in a time period immediately preceding the non-active period.

Otherwise, the BS may have to withdraw the handover procedure for some UEs due to the signaling congestion/overloading. To reduce or eliminate the occurrence of such a scenario, the BS can begin configuring the candidate cells (for the conditional handover case) and/or the triggering conditions (for both the legacy handover and conditional handover cases) to different UEs as early as possible, and allow some or all UEs to autonomously activate the triggering conditions shortly before the BS enters the cell non-active period. the BS should also ensure that the triggering conditions will not be blocked by the link condition of the serving cell, otherwise the handover procedure or the conditional handover procedure may not be properly triggered or executed.

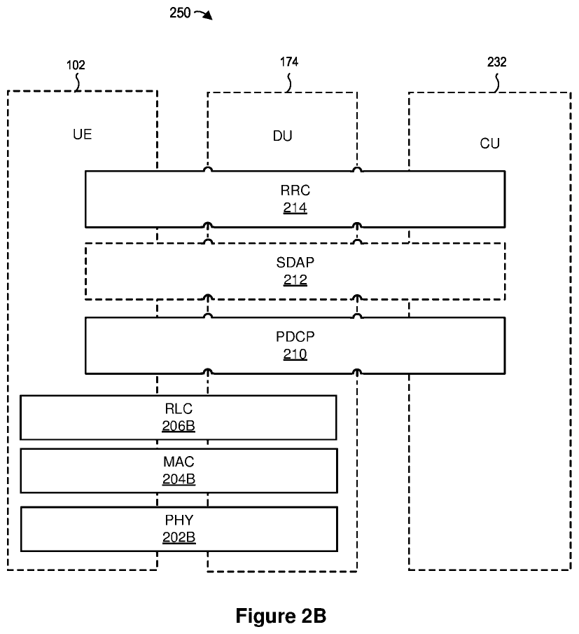

Next, several example scenarios in which a UE and/or a RAN perform the techniques of this disclosure for supporting network energy saving with enhanced handover procedure are discussed with reference to FIGS. 3-5. Generally speaking, similar events in FIGS. 3-5 are labeled with the similar reference numbers that share two least significant digits, with differences discussed below where appropriate. For example, event 409 is similar to event 509, event 435 is similar to event 535A and 535B, and event 336 is similar to event 436. To simplify the following description, the term “idle state” is used and can represent the RRC_IDLE or the RRC_INACTIVE state, and the term “connected state” is used and can represent the RRC_CONNECTED state.

FIG. 3A illustrates an example scenario 300A in which the UE 102 informs the network of the UE preference regarding NES support. The UE 102 initially establishes a connection with a cell of the BS 104 and operates in a connected state of a protocol for controlling a radio connection (e.g., RRC_CONNECTED). Meanwhile, another cell of the BS 106 is available to the UE 102 as a neighbor cell, which does not (currently) and is not expected to operate 304 in the NES mode (e.g., cell DTX/DRX mode) for the duration the example scenario shown in FIG. 3A. While remaining 302 in the connected state, the UE 102 transmits 308, to the BS 104, an indication (e.g., “NES_mode=support”) indicating the UE 102 can support NES via a UL Dedicated Control Channel (DCCH) message (e.g., UEAssistanceInformation). The BS 104 later determines 310 to start a cell non-active period (a period during which the BS may turn off the transmission and/or reception for data and/or reference signals) to save energy,. The BS 104 therefore transmits/broadcasts 320 a notification to the UE 102 indicating the upcoming cell non-active period. The BS 104 can include the notification in the event 320 in a system information, in a dedicated/common RRC message, in a DL MAC CE, or in a common DCI (e.g., a short message in the paging DCI).

After the BS 104 transmits 320 the notification, the UE 102 detects 330 that user activity at the UE 102 has changed significantly, and that the UE 102 needs to exchange a significant amount of data with the network (e.g., transmit and/or receive data in excess of a certain predefined or network threshold) within a certain time interval (e.g., the next X seconds). As a result, the UE 102 can no longer support the NES feature. The UE 102 transmits 332, to the BS 104, an indication (e.g., “NES_mode=non-support”') indicating the UE 102 is unable to support the NES or unable to align the cell DTX/DRX configuration, via a UL DCCH message (e.g., UEAssistanceInformation). More generally, UE 102 can detect 330 any suitable change in a condition of the UE that makes the DTX/DRX in the serving cell of the UE 102 undesirable. The change in condition can relate to the current communication requirements or anticipated (future) communication requirements.

In response to receiving 332 the negative NES indication, the BS 104 configures and transmits 334 to the UE 102 an updated measurement configuration including one or more measIds associating Event A4 with the neighbor cells with the NES feature disabled. Using these new measIds, the UE 102 can trigger measurement reporting. The UE 102 then transmits 336 a measurement report including the measurement results of the neighbor cells disabling the NES feature, to the BS 104.

Based on the received 336 measurement report, the BS 104 can determine to hand the UE 102 over to the BS 106, and transmits 340 a Handover Request message to the BS 106 via the Xn-AP interface. In response to receiving 340 the Handover Request message, the BS 106 transmits 342 a Handover Request Acknowledge message to the BS 104, to accept the handover request. Upon receiving the Handover Request Acknowledge message, the BS 104 transmits 346 a Handover Command message (i.e., the RRCReconfiguration message containing the reconfigurationWithSync IE) to the UE 102, which includes the target cell configurations and the Random Access (RA) resource to be used (by the UE) while executing the handover.

In response to receiving 346 the Handover Command message, the UE 102 starts 382 synchronizing with the target cell of the BS 106, by detecting and synchronizing with the SSBs transmitted by the BS 106. After the synchronization, the UE 102 transmits 384 the RA preamble, configured earlier in the Handover Command, to the target cell of the BS 106. The UE 102 then receives 386 a PDCCH providing a UL grant as the response to the RA preamble transmission.

Eventually, the UE 102 transmits 388 an RRC Reconfiguration Complete message to the target cell of the BS 106, which marks the end of the handover procedure. The events 382, 384, 384 and 388 are collectively referred to in FIG. 3A as the procedure 380 for “Synchronization and Handover Execution to the Target Cell” or as may be referred to hereinafter as the conditional handover (CHO) After the execution of the handover procedure, or during the execution of the handover procedure, the BS 104 may have already started 372 a cell non-active period for power saving purpose (e.g., NES as described earlier herein).

FIG. 3B is a messaging diagram 300 of another example scenario in which the UE 102 notifies UE the network of the UE preference regarding NES support, while the UE is being configured with the cell DTX/DRX configuration. The message diagram in FIG. 3A is similar to that in FIG. 3B, with the differences discussed below. In FIG. 3B, the BS 104 periodically starts a cell non-active period once per cell DTX/DRX cycle, rather than starting a cell non-active period dynamically. Therefore, after the UE 102 has connected to the BS 104, the BS 104 transmits or broadcasts 306 an RRC message indicating the cell DTX/DRX configuration (including the DTX/DRX cycle, the length of the cell non-active period, etc.) to the UE 102. The RRC message can include a system information message, a Common Control Channel (CCCH) message, or a DCCH message.

At a later time, after receiving 332 the negative NES indication from the UE 102, the BS 104 transmits 334, to the UE 102, an updated measurement configuration including one or more measIds associating the neighbor cell(s) and disabling the NES feature with a specific triggering event (e.g., EventA4), before starting 370 the next cell non-active period per the cell DTX/DRX configuration.

In both FIG. 3A and FIG. 3B, instead of sending an indication (e.g., NES_mode) indicating whether the UE 102 is able to support the NES via the UL DCCH message, the UE 102 may transmit UE preference regarding UE DRX configuration to implicitly indicate whether the UE 102 is able to support the NES, or is able to align the cell DTX/DRX configuration. With such a UE implementation, the BS 104 in FIG. 3A and FIG. 3B may determine to hand over the UE 102 to another BS, upon receiving a UE DRX preference not aligning the cell DTX/DRX configuration.

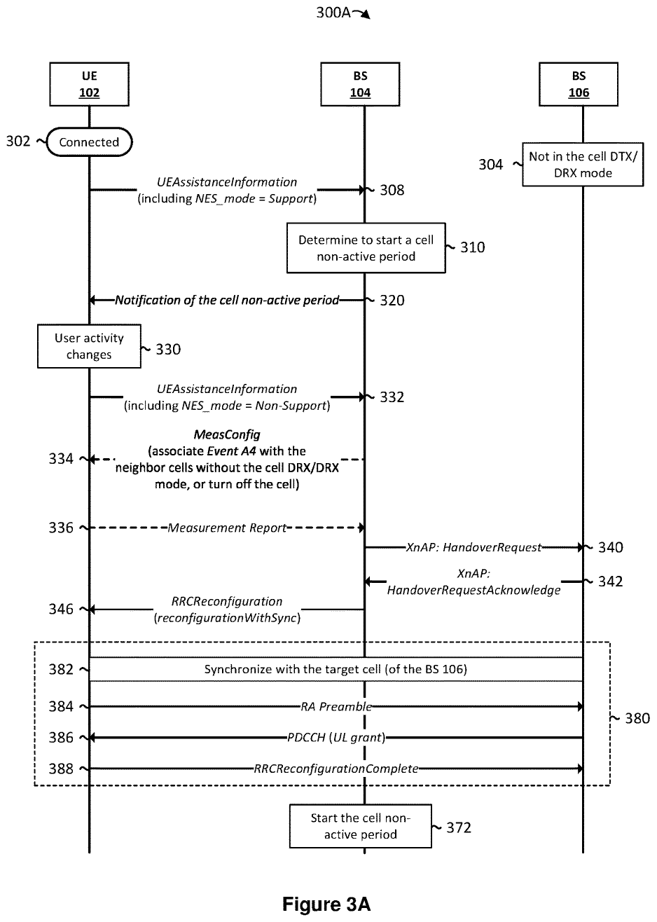

FIG. 4A is an example messaging diagram 400A demonstrating how a UE in the connected state autonomously transmits a UE logged or periodic measurement report to the BS, upon being notified of an upcoming cell non-active period. The message diagram in FIG. 4A is similar to that in FIG. 3A, with the differences discussed below. In FIG. 4A, it is assumed that the UE 102 is experiencing a high level of user activity and needs to be handed over to another cell if the serving cell is about to start a cell non-active period. It is also assumed in FIG. 4A that the UE 102 has been configured 405 to report measurement results periodically or has been configured to log measurement results.

If the UE 102 has been configured to report periodic measurement results earlier in the event 405, after the BS 104 notifies 320 the UE 102 of the upcoming cell non-active period, the UE 102 stops 437 the periodic reporting timer and transmits 438 a measurement report including the MeasId configured for the periodic reporting to the BS 104, and then starts 439 again the periodic reporting timer. If the UE 102 has been configured to log measurement results earlier in the event 405, after the BS 104 notifies 320 the UE 102 of the upcoming cell non-active period, the UE 102 transmits 438 a UE Information Response message including logged measurement report(s) to the BS 104.

Next, based on the received measurement report, the BS 104 may handover the UE 102 to the BS 106, after which the procedure proceeds similarly to that depicted in FIG. 3A.

FIG. 4B is an example messaging diagram 400B demonstrating how a UE in the connected state autonomously transmits an event-triggered measurement report to the BS, upon being notified of an upcoming cell non-active period. The message diagram in FIG. 4B is similar to that in FIG. 4A, with the differences discussed below. In FIG. 4B, the BS 104 transmits 409, to the UE 102, a measurement configuration including deactivated MeasId(s), which associate(s) UE neighbor cell(s) not operating in the cell DTX/DRX mode with a triggering event (for measurement reporting). In one implementation, the BS 104 signals a MeasId with a flag associated with the MeasId indicating whether the associated MeasId is being activated or deactivated. In another implementation, a MeasId is considered (by both the UE 102 and BS 104) as being deactivated automatically if the MeasId associates a measurement object with the triggering event EventA4. In yet another implementation, a MeasId is considered (by both the UE 102 and BS 104) as being deactivated automatically if the MeasId associates a measurement object with a new triggering event that does not consider the link quality of the serving cell, such as EventAx (x is a number larger than 4).

At a later time, the BS 104 determines 410 to start a cell non-active period and therefore notifies 420 the UE 102 of the upcoming cell non-active period. In response to the notification of the cell non-active period, the UE 102 activates the MeasId(s) that have been deactivated since the event 409. As a result, the UE 102 starts 436 sending the measurement report to the BS 104, which then triggers the subsequent handover procedure for the UE 102.

FIG. 4C is an example messaging diagram 400C of demonstrating how a UE in the connected state autonomously transmits a UE event-triggered measurement report to the BS, prior to the arrival of a regular cell non-active period. The message diagram in FIG. 4C is similar to that in FIG. 3B, with the differences discussed below. In FIG. 4C, it is assumed that the UE 102 is experiencing a high level of user activity and needs to be handed over to another cell if the serving cell is about to start a cell non-active period.

In FIG. 4C, after transmitting 306 an RRC message indicating the cell DTX/DRX configuration, the BS 104 transmits 409, to the UE 102, a measurement configuration including deactivated MeasId(s), which associate(s) UE neighbor cell(s) not operating in the cell DTX/DRX mode with a triggering event (for measurement reporting). In one implementation, the BS 104 signals a MeasId together with a flag associated with the MeasId indicating whether the associated MeasId is being activated or deactivated. In another implementation, a MeasId is considered (by both the UE 102 and BS 104) as being deactivated automatically if the MeasId associates a measurement object with the triggering event EventA4. In yet another implementation, a MeasId is considered (by both the UE 102 and BS 104) as being deactivated automatically if the MeasId associates a measurement object with a new triggering event that does not consider the link quality of the serving cell, such as EventAx (x is a number larger than 4).

After receiving the measurement configuration including the deactivated MeasId(s), the UE 102 continuously determines if the remaining time until the next cell non-active period is less than X time units, where X can be an integer or a floating point value, and where the time units can be minutes, seconds, mini-seconds, frames, subframes, or slots. If the determination is negative (i.e., the remaining time until the next cell non-active period is equal to or larger than X time units), the UE 102 takes no action. However, if the determination is positive (i.e., the remaining time until the next cell non-active period is less than X time units), the UE 102 activates the deactivated MeasId(s) configured since the event 409.

In FIG. 4C, because the UE 102 determines the remaining time until the next cell non-active period is less than X time units in the event 435, the UE activates the MeasId(s) that have been deactivated since the event 409. As a result, the UE 102 starts 436 sending the measurement report to the BS 104, which then triggers the subsequent handover procedure for the UE 102.

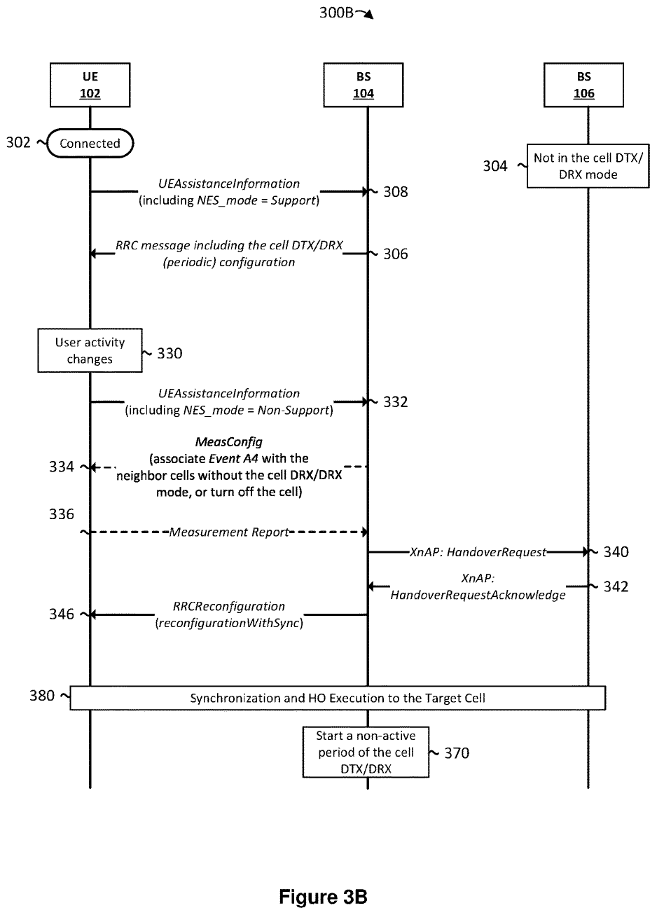

FIG. 5A is a messaging diagram of an example scenario 500A in which a UE in the connected state autonomously triggers the candidate cell evaluation for the conditional handover (CHO) execution, upon being notified of an upcoming cell non-active period. In the scenario 500A, the UE 102 initially establishes a connection with a cell managed by the BS 104, and then remains 502 in the connected state. Meanwhile, another cell managed by BS 106 becomes available to the UE 102 as a neighbor cell, which does not and will not operate 504 in the NES mode (e.g., cell DTX/DRX mode) for the duration of the example illustrated in FIG. 5A.

The BS 104 then proactively prepares the CHO candidates for the UE 102 by transmitting 540 Handover Request messages to candidates including the BS 106, for the preparation of a potential cell non-active period in the future. In response to receiving 540 the Handover Request message, the BS 106 transmits 542 a Handover Request Acknowledge message to the BS 104, to accept the handover request. Upon receiving 542 the Handover Request Acknowledge message, the BS 104 transmits 509 a conditionalReconfiguration IE (via the RRCReconfiguration message) including one or more than one candidate cell configurations to the UE 102, where at least one of the candidate cell configurations contains a CHO execution condition (i.e., MeasId) being deactivated. In one implementation, the BS 104 signals a MeasId together with a flag associated WITH the MeasId indicating whether this MeasId is being activated or deactivated. In another implementation, a MeasId is considered (by both the UE 102 and BS 104) as being deactivated automatically if the MeasId associates the candidate cell with the CHO event condEventA4. In yet another implementation, a MeasId is considered (by both the UE 102 and BS 104) as being deactivated automatically if the MeasId associates the candidate cell with a “new” CHO event (i.e., defined specifically in connection with CHO) that does not evaluate the link quality of the serving cell, such as condEventAx (x is a number larger than 4).

After that, the BS 104 determines 310 to start a cell non-active period (a period in which the BS may turn off the transmission and/or reception for data and/or reference signals) for energy saving considerations, and therefore the BS 104 transmits/broadcasts a notification to the UE 102 notifying of the upcoming cell non-active period. The notification sent in the event 320 can be carried in a system information, in a dedicated/common RRC message, in a DL MAC CE, or in a common DCI (e.g., short message in the paging DCI).

In response to the notification of the cell non-active period, the UE 102 activates 535A the MeasId(s) that have been deactivated since the event 509. As a result, the UE 102 starts evaluating certain candidate cells using the newly activated CHO execution conditions, and determines 548 to execute the CHO to the cell of BS 106, upon condEventA4 of the cell being fulfilled. Subsequently, the UE 102 synchronizes and executes the CHO 380 with the cell of the BS 106.

FIG. 5B is a messaging diagram 500B of an example demonstrating a UE in the connected state selectively triggering the candidate cell evaluation for the CHO execution, upon being notified of an upcoming cell non-active period. The message diagram in FIG. 5B is similar to that in FIG. 5A, with the differences discussed below. In FIG. 5B, after transmitting/broadcasting a notification to the UE 102 notifying of the upcoming cell non-active period, the BS 104 further transmits an assistance information to the UE 102, which can be used by UE 102 to determine which candidate cell evaluation to be activated. The assistance information can include (Alternative #1) a list of the neighbor cells that do not and will not operate in the cell DTX/DRX mode, or (Alternative #2) a dedicated DCI or a dedicated DL MAC CE indicating the condReconfigId(s) whose CHO execution condition(s) (i.e., measIds) shall be activated.

In response to the notification of the cell non-active period and the assistance information, the UE 102 activates 535B the deactivated MeasId(s) within certain condReconfigId(s), according to the information provided in the assistance information. If the assistance information includes a list of neighbor cells, the UE activates the MeasId(s) that have been considered as deactivated and are associated with the neighbor cells in the list. If the assistance information is a DCI or DL MAC CE indicating the condReconfigId(s), the UE activates the MeasId(s) that have been considered as deactivated and are within the condReconfigId(s) indicated by the DCI or DL MAC CE.

FIG. 5C is a messaging diagram 500C of an example demonstrating a UE in the connected state autonomously triggering the candidate cell evaluation for the conditional handover (CHO) execution, prior to the arrival of a regular cell non-active period. The message diagram in FIG. 5C is similar to that in FIG. 5A, with the differences discussed below. In FIG. 5C, the BS 104 starts periodically a cell non-active period taking place once per cell DTX/DRX cycle, instead of starting a cell non-active period dynamically. Therefore, after the UE 102 has connected to the BS 104, the BS 104 transmits 506 an RRC message indicating the cell DTX/DRX configuration (including the DTX/DRX cycle, the length of the cell non-active period, etc.) to the UE 102, where the RRC message can be a system information message, a Common Control Channel (CCCH) message, or a DCCH message.

In FIG. 5C, after receiving 509 a conditionalReconfiguration IE including at least one CHO execution condition (i.e., MeasId) being deactivated, the UE 102 continuously determines if the remaining time until the next cell non-active period is less than X time units, where X can include an integer or a floating point value, and the time units can include minutes, seconds, milliseconds, frames, subframes, or slots. If the determination is negative (i.e., the remaining time until the next cell non-active period is equal to or larger than X time units), the UE 102 may take no action. However, if the determination is positive (i.e., the remaining time until the next cell non-active period is less than X time units), the UE 102 activates the deactivated MeasId(s) configured since the event 509.

In FIG. 5C, because the UE 102 determines the remaining time until the next cell non-active period is less than X time units in the event 535A, the UE activates all the MeasId(s) that have been deactivated since the event 509. As a result, the UE 102 starts evaluating certain candidate cells using the newly activated CHO execution conditions, and determines 548 to execute the CHO to the cell of BS 106, upon condEventA4 of the cell being fulfilled. Subsequently, the UE 102 synchronizes and executes the CHO 380 with the cell of the BS 106.

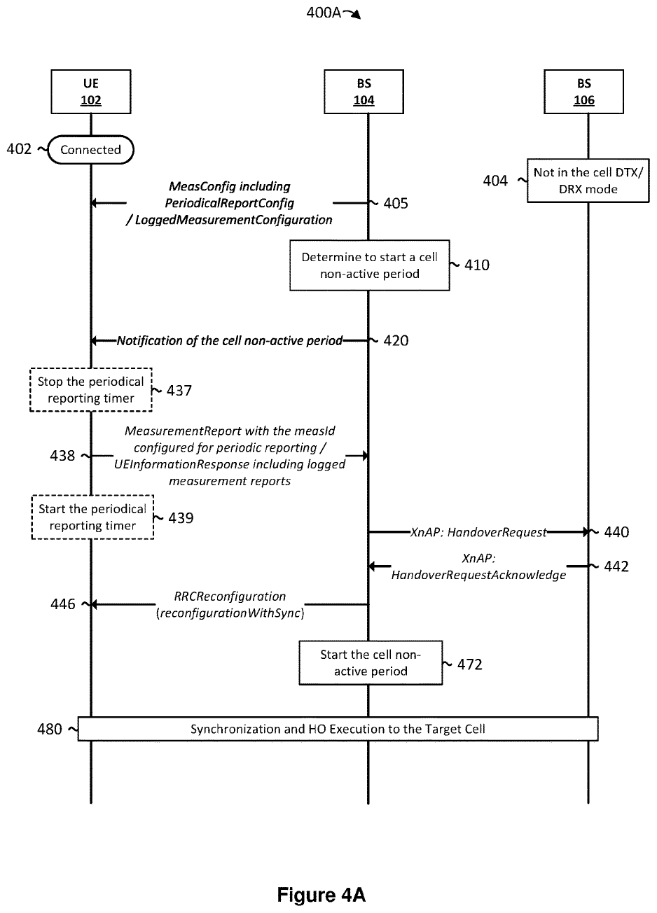

FIG. 6 is a flow diagram of an example method 600 that can be implemented by a UE (e.g., UE 102 in this disclosure) in the connected state, for informing the BS of UE status regarding whether the UE can support the cell DTX/DRX mode. Initially, at block 607, the UE evaluates whether the UE is able to support the cell DTX/DRX mode based on real-time user activity and/or the real-time traffic situation.

Based on the evaluation result obtained in the block 607, the UE transmits, to the BS, at block 608, a flag indicating whether the UE is able to support the cell DTX/DRX mode. In one implementation, the flag is carried in a UL DCCH message, such as the UEAssistanceInformation message. In another implementation, the flag is carried in a UL DCCH message responding to a DL DCCH inquiry message, such as the UEInformationResponse message.

Subsequently, the flow proceeds to the decision block 690, where the UE determines whether the real-time user activity and/or traffic situation has changed. If the determination at block 690 is ‘YES’ (i.e., the real-time user activity and/or traffic situation has changed), the method 600 returns to the block 608. Otherwise (i.e., the real-time user activity and/or traffic situation does not change), the method flow returns to the decision block 690.

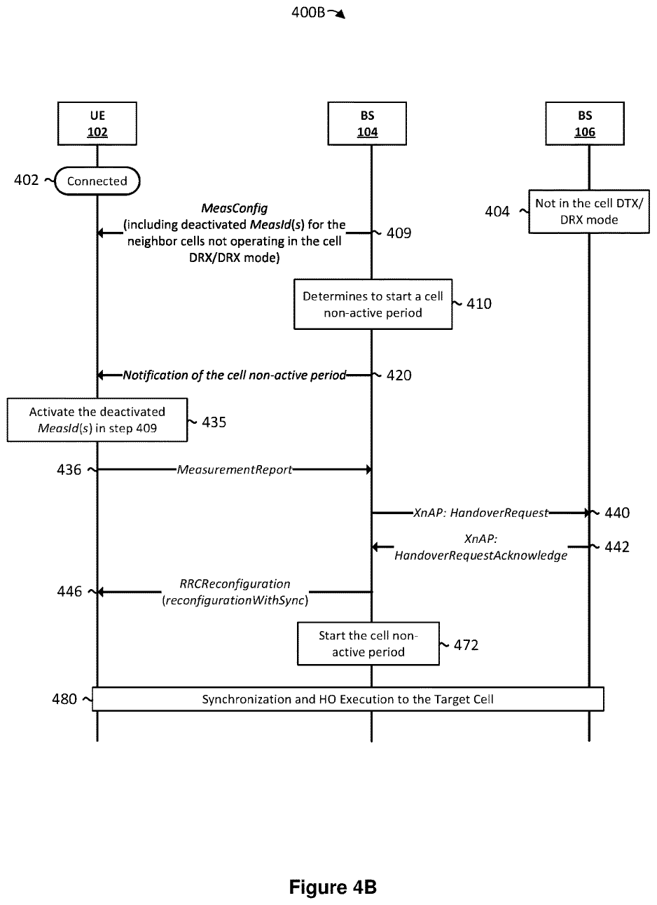

Next, example methods that can be implemented by a UE are discussed with reference to FIGS. 7-13. Generally speaking, similar blocks in FIGS. 7-13 are labeled with the similar reference numbers that share two least significant digits, with differences discussed below where appropriate. For example, block 720 is similar to blocks 820, 1020, 1120, and 1220; block 809 is similar to block 909; block 906 is similar to block 1306; and block 1009 is similar to blocks 1109, 1209 and 1309.

FIG. 7 is a flow diagram of an example method 700 that can be implemented by a UE (e.g., UE 102 in this disclosure) in the connected state, for transmitting its logged or periodic measurement report upon being informed of a cell non-active period. Initially, at block 705, the UE receives, from a BS, a logged measurement configuration, or a measurement configuration including a periodic reporting configuration, where the logged measurement configuration can be carried in the LoggedMeasurementConfiguration message and the periodic reporting configuration can be carried in the PeriodicalReportConfig IE (within the MeasConfig IE).

After that, the UE receives, from the BS, at block 720, a notification of the cell non-active period. In response to the notification, the UE transmits, to the BS, at block 738, a logged measurement report, or a periodic measurement report, depending on which type of reporting has been configured to the UE. If both types of reporting (i.e., logged measurement report and periodic measurement report) have been configured to the UE, to the reporting type can be left to UE implementation, to a pre-defined rule specified in the specification (e.g., periodic measurement reporting has higher priority or vice versa), or to the network configuration (e.g., network indicates the periodic measurement reporting has higher priority or the other way around), to determine which type of reporting the UE would perform.

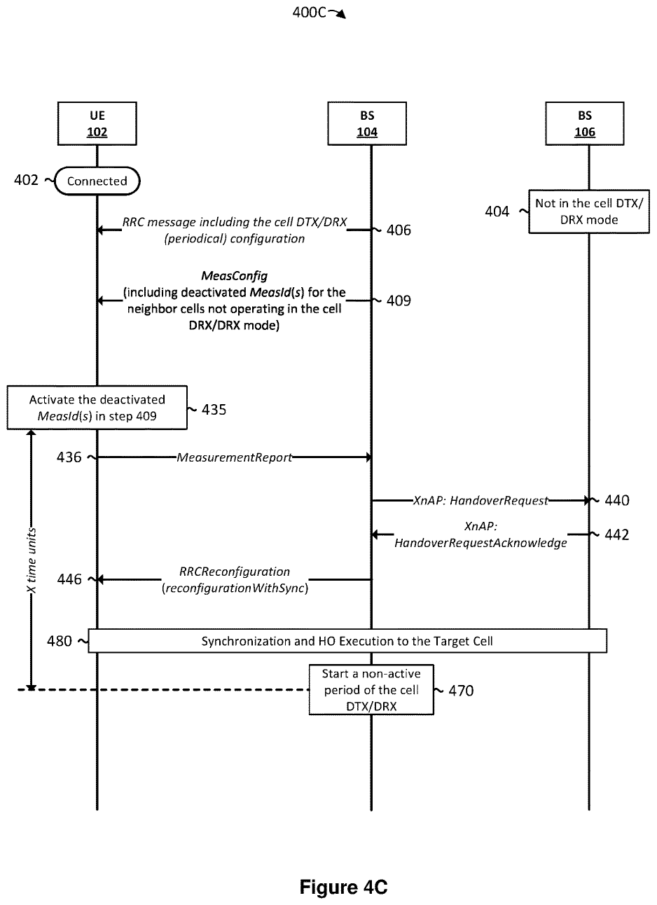

FIG. 8 is a flow diagram of an example method 800 that can be implemented by a UE (e.g., UE 102 in this disclosure) in the connected state, for activating deactivated measurement identities upon being informed of a cell non-active period. Initially, at block 809, the UE receives, from a BS, a measurement configuration including deactivated MeasId(s), where a MeasId is considered deactivated if the MeasId is signaled together with a deactivated indication, associates a measurement object with the triggering event EventA4, or associates a measurement object with a new triggering event that does not consider the link quality of the serving cell, such as EventAx (x is a number larger than 4).

Subsequently, the UE receives, from the BS, at block 820, a notification of the cell non-active period. In response to the notification, the UE activates, at block 835, all the MeasId(s) that have been considered as deactivated since the block 809.

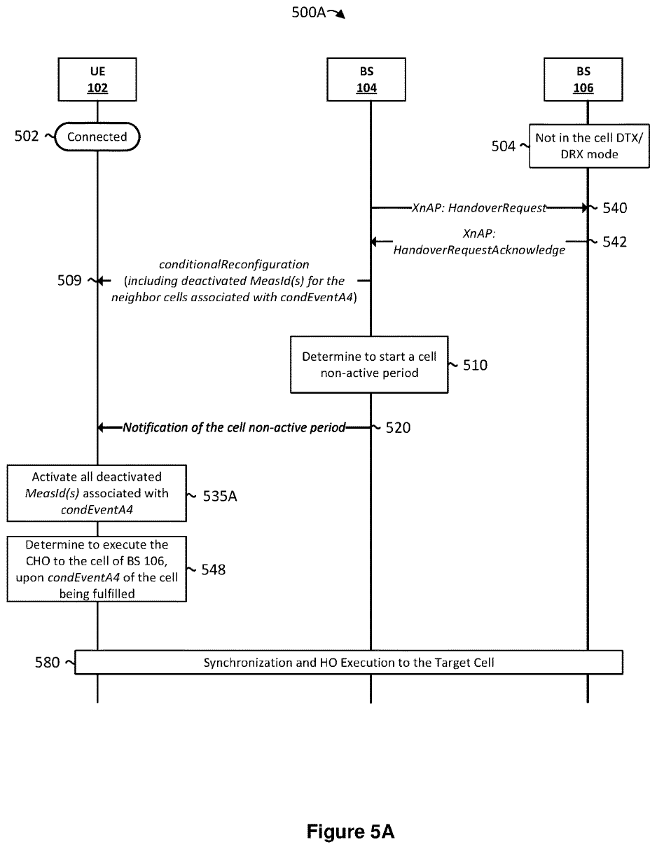

FIG. 9 is a flow diagram of an example method 900 that can be implemented by a UE (e.g., UE 102 in this disclosure) in the connected state, for activating deactivated measurement identities prior to the arrival of a pre-configured cell non-active period. Initially, at block 906, the UE receives, from a BS, an RRC message including one or multiple cell DTX/DRX configuration(s). The UE also receives, at block 809, a measurement configuration including deactivated MeasId(s), where a MeasId is considered as being deactivated if it is signaled together with a deactivated indication, associates a measurement object with the triggering event EventA4, or associates a measurement object with a new triggering event that does not consider the link quality of the serving cell, such as EventAx (x is a number larger than 4).

Subsequently and X time units before the arrival of the cell non-active period, the UE activates the MeasId(s) that have been considered as deactivated since the block 909, where X can include an integer or a float point value, and the time units can include minutes, seconds, milliseconds, frames, subframes, or slots.

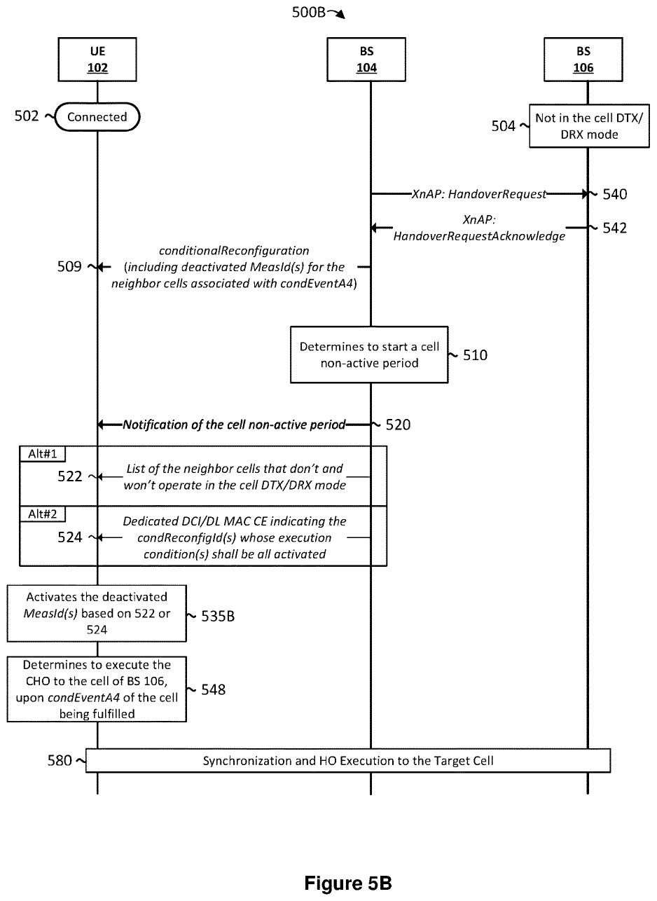

FIG. 10 is a flow diagram of an example method 1000 that can be implemented by a UE (e.g., UE 102 in this disclosure) in the connected state, for activating deactivated CHO execution condition(s) upon being informed of a cell non-active period. Initially, at block 1009, the UE receives, from a BS, a conditional reconfiguration including deactivated MeasId(s), where a MeasId is considered deactivated if the MeasId is signaled together with a deactivated indication, associates a candidate cell with the CHO event condEventA4, or associates a candidate cell with a new CHO event that does not evaluate the link quality of the serving cell, such as condEventAx (x is a number larger than 4).

Subsequently, the UE receives, from the BS at block 1020, a notification of the cell non-active period. In response to the notification, the UE activates, at block 1035, the MeasId(s) that have been considered as deactivated since the block 1009.

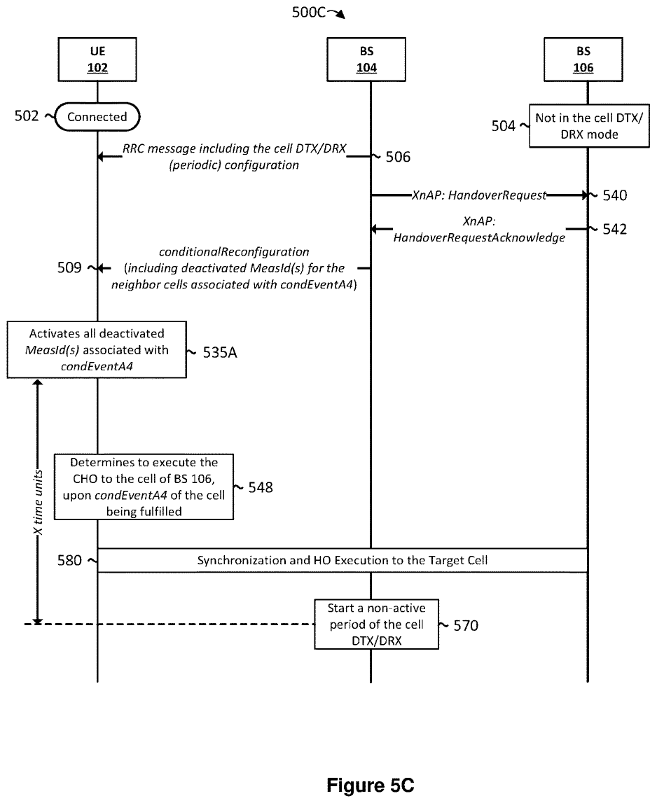

FIG. 11 is a flow diagram of an example method 1100 that can be implemented by a UE (e.g., UE 102 in this disclosure) in the connected state, for selectively activating deactivated CHO execution condition based on a list of neighbor cells provided by the BS. Initially, at block 1109, the UE receives, from a BS, a conditional reconfiguration including deactivated MeasId(s), where a MeasId is considered deactivated if the MeasId is signaled together with a deactivated indication, associates a candidate cell with the CHO event condEventA4, or associates a candidate cell with a new CHO event that does not evaluate the link quality of the serving cell, such as condEventAx (x is a number larger than 4).

Subsequently, the UE receives, from the BS at block 1120, a notification of the cell non-active period. The UE also receives, at block 1122, a list of neighbor cells that do not and will not operate in the cell DTX/DRX mode. In response to the notification of the cell non-active period and the list of neighbor cells, the UE 102 activates, at block 1135, the MeasId(s) that have been considered as deactivated and are associated with the neighbor cells in the list.

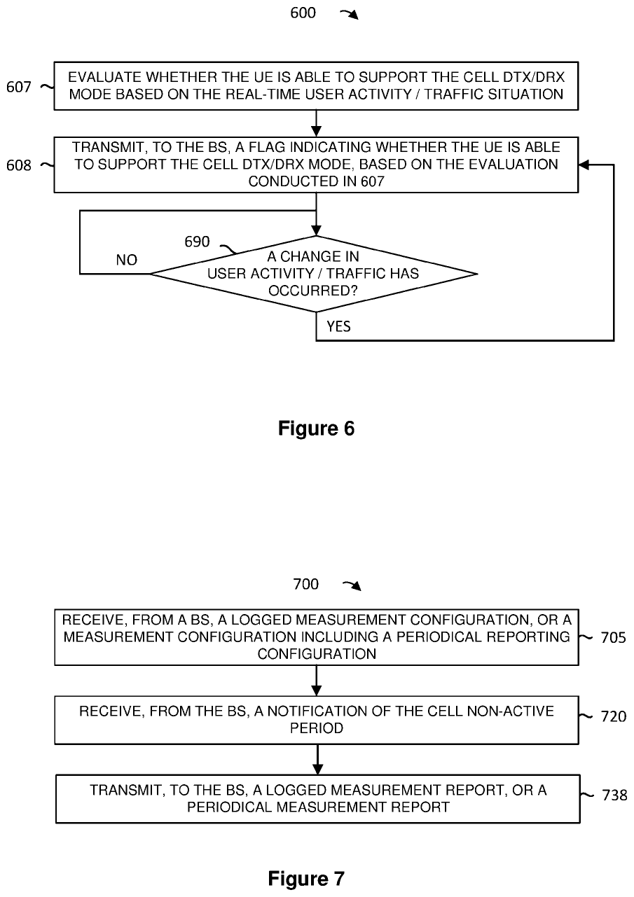

FIG. 12 is a flow diagram of an example method 1200 that can be implemented by a UE (e.g., UE 102 in this disclosure) in the connected state, for selectively activating deactivated CHO execution condition based on the DCI or DL MAC CE provided by the BS. Initially, at block 1209, the UE receives, from a BS, a conditional reconfiguration including deactivated MeasId(s), where a MeasId is considered as being deactivated if the MeasId is signaled together with a deactivated indication, associates a candidate cell with the CHO event condEventA4, or associates a candidate cell with a new CHO event that does not evaluate the link quality of the serving cell, such as condEventAx (x is a number larger than 4).

After that, the UE receives, from the BS, at block 1220, a notification of the cell non-active period. The UE also receives, at block 1224, a dedicated DCI or a dedicated DL MAC CE indicating certain condReconfigId(s). In response to the notification of the cell non-active period and the DCI/DL MAC CE, the UE 102 activates, at block 1235, the MeasId(s) that have been considered as deactivated and are within the condReconfigId(s) indicated by the DCI/DL MAC CE.

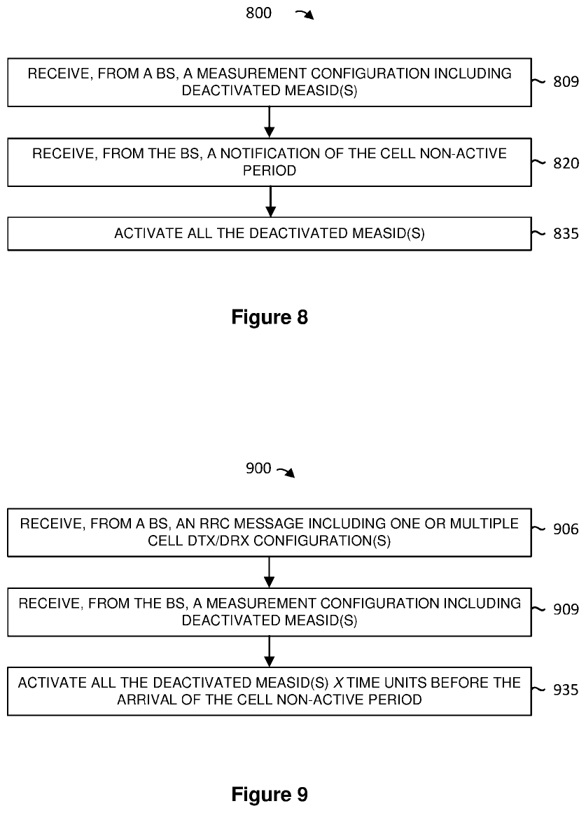

FIG. 13 is a flow diagram of an example method 1300 that can be implemented by a UE (e.g., UE 102 in this disclosure) in the connected state, for activating deactivated CHO execution condition prior to the arrival of a pre-configured cell non-active period. Initially, at block 1306, the UE receives, from a BS, an RRC message including one or multiple cell DTX/DRX configuration(s). The UE also receives, at block 1309, a conditional reconfiguration including deactivated MeasId(s), where a MeasId is considered as being deactivated if the MeasId is signaled together with a deactivated indication, associates a candidate cell with the CHO event condEventA4, or associates a candidate cell with a new CHO event that does not evaluate the link quality of the serving cell, such as condEventAx (x is a number larger than 4).

Subsequently and X time units before the arrival of the cell non-active period, the UE activates the MeasId(s) that have been considered as deactivated since the block 1009, where X can be an integer or a float point value, and the time units can be in minutes, seconds, milliseconds, frames, subframes, or slots.

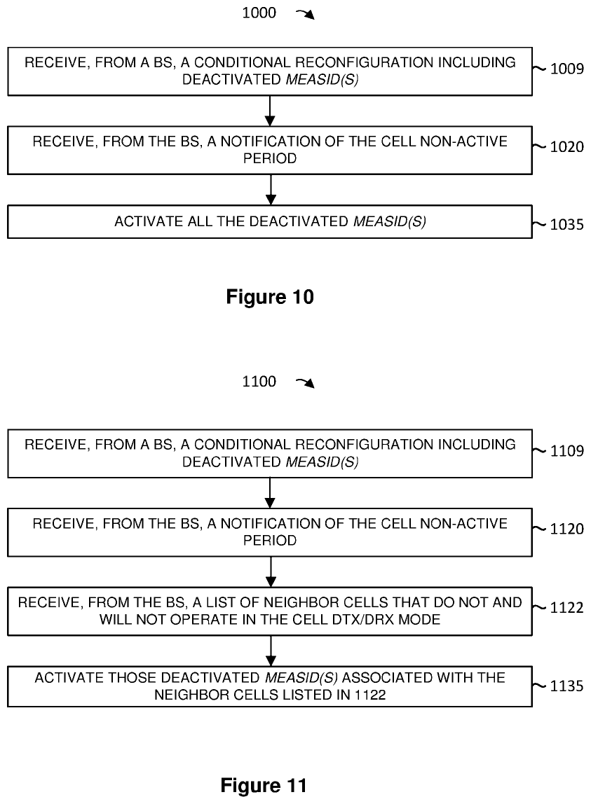

Next, example methods that can be implemented by a BS are discussed with reference to FIGS. 14-19. Generally speaking, similar blocks in FIGS. 14-19 are labeled with the similar reference numbers that share two least significant digits, with differences discussed below where appropriate. For example, block 1406 is similar to block 1706, block 1510 is similar to blocks 1610 and 1710, block 1520 is similar to blocks 1620 and 1720 and block 1709 is similar to blocks 1809 and 1909.

FIG. 14 is a flow diagram of an example method 1400 that can be implemented by a BS (e.g., BS 104 in this disclosure), for determining whether to handover a UE based on UE preference for supporting the NES feature. Initially, at block 1406, the BS transmits or broadcasts, to a UE, an RRC message including one or multiple cell DTX/DRX configuration(s), where the DTX/DRX configurations may include a DTX/DRX cycle length and a length of the cell non-active period, and the RRC message can be a system information message, a Common Control Channel (CCCH) message, or a DCCH message. The BS may skip the block 1406 if the BS determines to activate a cell non-active period in a dynamic manner.

The flow then proceeds to the decision block 1432, where the BS determines if the BS has received a flag/indication from the UE indicating the UE is not able to support the network energy saving feature (e.g., not able to support the cell DTX/DRX mode). If the determination at the decision block 1432 is ‘NO’, the flow loops back to the decision block 1432 again. Otherwise (i.e., the branch ‘YES’ after the decision block 1432), the flow proceeds to another decision block 1410, where the BS determines if the BS is about to start a cell non-active period. If the determination at the decision block 1410 is ‘NO’, the flow loops back to the decision block 1432. Otherwise (the branch ‘YES’ after the decision block 1432), the flow further proceeds to the block 1440, where the BS starts the procedure for handing over the UE to a neighbor cell.

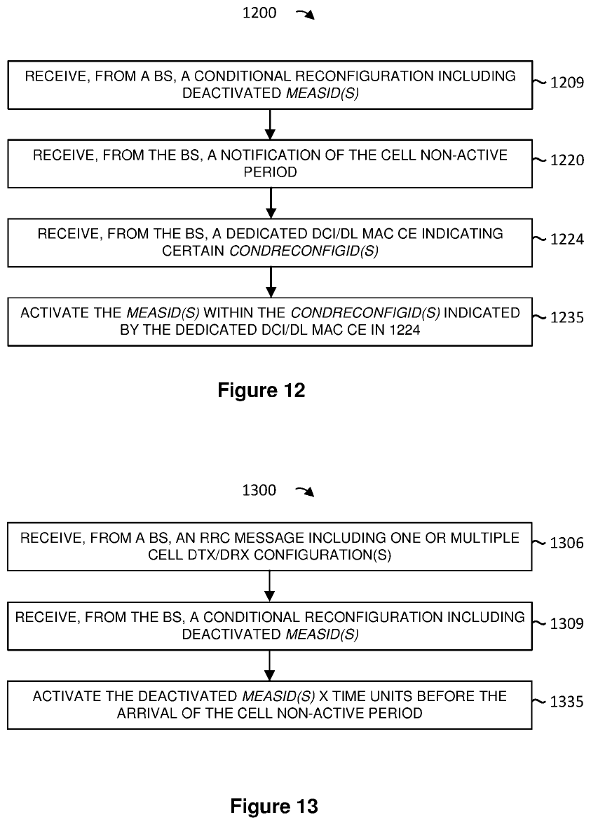

FIG. 15 is a flow diagram of an example method 1500 that can be implemented by a BS (e.g., BS 104 in this disclosure), for receiving a logged or a periodic measurement report from a UE before starting a cell non-active period. Initially, at block 1505, the BS transmits, to a UE, a logged measurement configuration, or a measurement configuration including a periodic reporting configuration.

At a later time, the BS determines, at block 1510, to start a cell non-active period for the power saving purpose, and then broadcasts/transmits, to the UE, at block 1520, a notification notifying the upcoming of a cell non-active period. After that, the BS receives, from the UE, at block 1538, a logged measurement report or a periodic measurement report that can be used by the BS to determine whether to handover the UE to a neighbor cell or not.

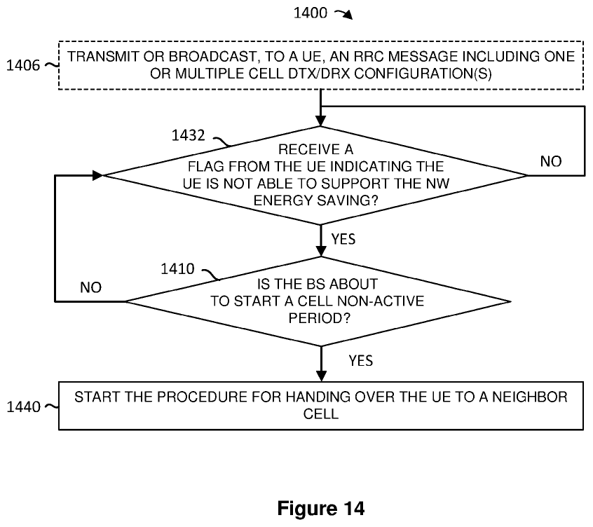

FIG. 16 is a flow diagram of an example method 1600 that can be implemented by a BS (e.g., BS 104 in this disclosure), for configuring a UE with one or more deactivated MeasId(s) that can be activated autonomously by the UE later. Initially, at block 1609, the BS transmits, to a UE, a measurement configuration including one more deactivated MeasId(s), where a MeasId is considered as being deactivated if the MeasId is signaled together with a deactivated indication, associates a measurement object with the triggering event EventA4, or associates a measurement object with a new triggering event that does not consider the link quality of the serving cell, such as EventAx (x is a number larger than 4).

At a later time, the BS determines, at block 1510, to start a cell non-active period for power saving purposes, and then broadcasts/transmits, to the UE, at block 1620, a notification notifying the upcoming of a cell non-active period. After that, the BS receives, from the UE, at block 1636, a measurement report including a MeasId that was deactivated since the block 1609.

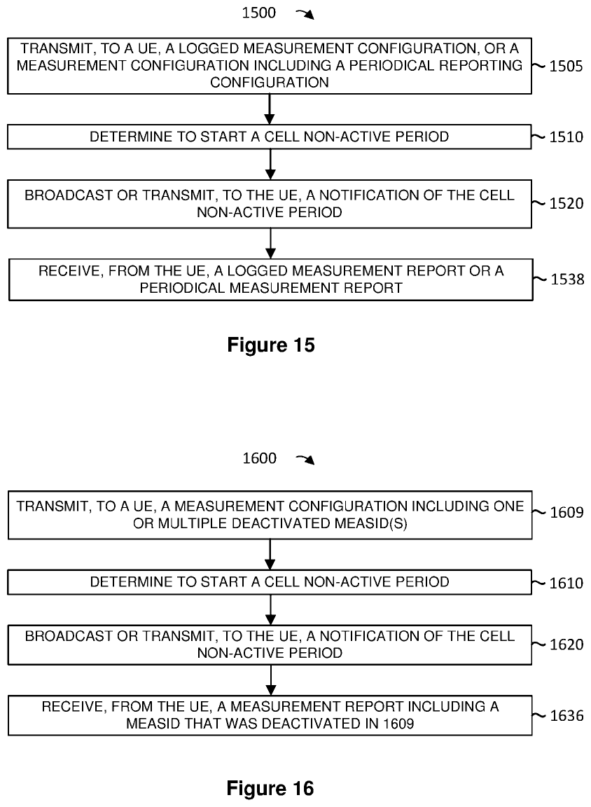

FIG. 17 is a flow diagram of an example method 1700 that can be implemented by a BS (e.g., BS 104 in this disclosure), for configuring a UE with a CHO configuration including one or more deactivated CHO execution conditions that can be subsequently activated autonomously by the UE. Initially, at block 1706, the BS transmits or broadcasts, to a UE, an RRC message including one or multiple cell DTX/DRX configuration(s), where the DTX/DRX configurations may include a DTX/DRX cycle length and a length of the cell non-active period, and the RRC message can be a system information message, a Common Control Channel (CCCH) message, or a DCCH message. The BS may skip the block 1706 if the BS determines to activate a cell non-active period in a dynamic manner.

The BS also transmits, to the UE, at block 1709, a conditional reconfiguration (i.e., CHO configuration) including one or multiple deactivated MeasId(s), where a MeasId is considered as being deactivated if the MeasId is signaled together with a deactivated indication, associates a candidate cell with the CHO event condEventA4, or associates a candidate cell with a new CHO event that does not evaluate the link quality of the serving cell, such as condEventAx (x is a number larger than 4).

At a later time, the BS determines, at block 1710, to start a cell non-active period for power saving purposes, and then broadcasts/transmits, to the UE, at block 1720, a notification notifying the upcoming of a cell non-active period. The BS may skip the blocks 1710 and 1720 if the BS determines to periodically start a cell non-active period based on the pre-configured DTX/DRX configuration.

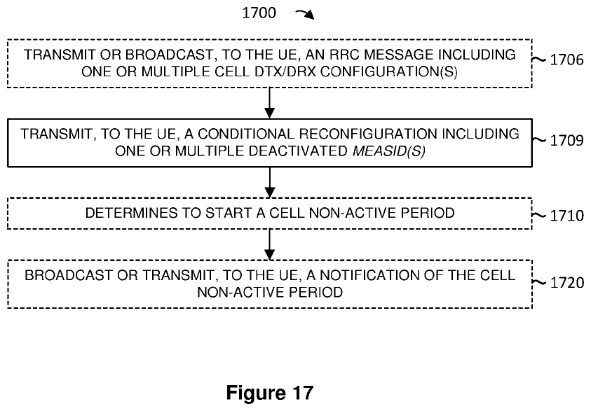

FIG. 18 is a flow diagram of an example method 1800 that can be implemented by a BS (e.g., BS 104 in this disclosure), for configuring a UE with a CHO configuration including one or multiples deactivated CHO execution conditions, which can be activated later based on a list of neighbor cells. Initially, at block 1809, the BS transmits, to a UE, a conditional reconfiguration (i.e., CHO configuration) including one or multiple deactivated MeasId(s), where a MeasId is considered as being deactivated if the MeasId is signaled together with a deactivated indication, associates a candidate cell with the CHO event condEventA4, or associates a candidate cell with a new CHO event that does not evaluate the link quality of the serving cell, such as condEventAx (x is a number larger than 4).

At a later time, the BS transmits or broadcasts, to a UE, at block 1822, an RRC message including a list of neighbor cells that do not and will not operate in the cell DTX/DRX mode.

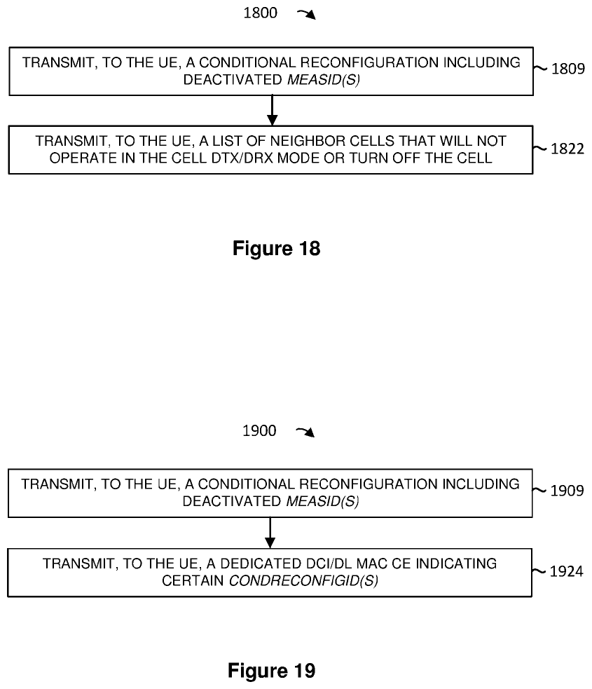

FIG. 19 is a flow diagram of an example method 1900 that can be implemented by a BS (e.g., BS 104 in this disclosure), for configuring a UE with a CHO configuration including one or multiples deactivated CHO execution conditions, which can be activated later based on a DCI or a DL MAC CE. Initially, at block 1909, the BS transmits, to a UE, a conditional reconfiguration (i.e., CHO configuration) including one or multiple deactivated MeasId(s), where a MeasId is considered as being deactivated if the MeasId is signaled together with a deactivated indication, associates a candidate cell with the CHO event condEventA4, or associates a candidate cell with a new CHO event that does not evaluate the link quality of the serving cell, such as condEventAx (x is a number larger than 4).

At a later time, the BS transmits or broadcasts, to a UE, at block 1924, a dedicated DCI or a dedicated DL MAC CE indicating the condReconfigId(s) within which the UE can activate the MeasId(s).

The following list of examples reflects a variety of embodiments explicitly contemplated by the present disclosure.

Example 1. A method for facilitating power saving at a node of a radio access network (RAN), the method implemented in a user equipment (UE) and comprising: transmitting, to the node at a first time, a first indication to indicate that the UE can support power saving at the node; and transmitting, to the node at a second time and in response to a change in a condition of the UE, a second indication to indicate that the UE cannot support power saving at the node.

Example 2. The method of example 1, wherein the transmitting of the first indication occurs when the UE operates in a connected state of a protocol for controlling radio resources between the UE and the node.

Example 3. The method of example 1, wherein the first indication is included in a first UE assistance information IE; and the second indication is included in a second UE assistance information IE.

Example 4. The method of any of the preceding examples, further comprising, subsequently to the transmitting of the first indication receiving, from the node, a notification of a non-active period in a cell in which the UE current operates.

Example 5. The method of example 4, further comprising, in response to the receiving of the notification of the non-active period: stopping a timer according to which the UE periodically reports measurements of signals in neighbor cells to the RAN; and transmitting a measurement report including measurements of the signals in the neighbor cells.

Example 6. The method of example 5, further comprising restarting the timer in response to the transmitting of the measurement report.

Example 7. The method of any of examples 1-3, further comprising receiving, from the node, a discontinuous transmission (DTX) and/or discontinuous reception (DRX) configuration for a cell in which the UE current operates.

Example 8. The method of example 4 or 7, wherein the receiving of the notification or of the DTX/DRX configuration includes receiving a unicast radio resource control (RRC) message.

Example 9. The method of claim 4 or 7, wherein the receiving of the notification includes receiving a broadcast message.

Example 10. The method of any of the preceding examples, wherein the change in the condition of the UE includes an increase in an amount of data the UE is to exchange with the RAN within a certain interval of time.

Example 11. The method of any of examples 1-9, wherein the change in the condition of the UE includes a change in a latency requirement at the UE.

Example 12. The method of any of the preceding examples, further comprising receiving, from the node, a measurement configuration for a neighbor cell, the measurement configuration including an indication that the neighbor cell has not activated power saving.

Example 13. The method of example 12, wherein the measurement configuration maps the neighbor cell to a measurement report triggering event corresponding to a neighbor cell exceeding a threshold measurement.

Example 14. The method of claim of example 13, wherein the measurement report triggering event is Event A4.

Example 15. The method of any of the preceding claims, further comprising: receiving, from the RAN, a deactivated measurement configuration for a neighbor cell, the measurement configuration including an indication that the neighbor cell has not activated power saving; and in response to determining that the node has activated the power saving, activating the measurement configuration for the neighbor cell.

Example 16. A method for supporting power saving at a node of a radio access network (RAN), the method implemented in a user equipment (UE) operating in a cell of the node, the method comprising: receiving, from the RAN, a deactivated measurement configuration for a neighbor cell, the measurement configuration including an indication that the neighbor cell has not activated power saving; and in response to the node activating the power saving in the cell, reactivating the measurement configuration for the neighbor cell.

Example 17. A method for supporting power saving at a node of a radio access network (RAN), the method implemented in a user equipment (UE) operating in a first cell of the node, the method comprising: performing measurements in a second cell for reporting the measurements in the first cell according to a reporting period; in response to the node activating the power saving in the cell: reporting the measurements outside the reporting period.

Example 18. The method of example 17, further comprising: stopping a reporting period timer in response to the node activating the power saving in the cell; and restarting the reporting period timer in response to the reporting of the measurements outside the reporting period.

Example 19. A UE comprising a transceiver; and processing hardware configured to implement a method according to any of the preceding examples.

Example 20. A method for power saving, the method implemented in a node of a radio access network (RAN) and comprising: receiving, from a UE operating in a cell of the node, an indication that the UE cannot support power saving at the node; and in response to activating the power saving at the node, initiating a handover procedure for the UE.

Example 21. A base station comprising: a transceiver; and processing hardware configured to implement a method according to claim 20.

The following description may be applied to the description above.

Generally speaking, description for one of the above figures can apply to another of the above figures. Examples, implementations and methods described above can be combined, if there is no conflict. An event or block described above can be optional or omitted. For example, an event or block with dashed lines in the figures can be optional. In some implementations, “message” is used and can be replaced by “information element (IE)”, and vice versa. In some implementations, “IE” is used and can be replaced by “field”, and vice versa. In some implementations, “configuration” can be replaced by “configurations” or “configuration parameters”, and vice versa. In some implementations, “some” means “one or more”. In some implementations, “at least one” means “one or more”.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router.

Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code, or machine-readable instructions stored on non-transitory machine-readable medium) or hardware modules. A hardware module is a tangible unit capable of performing certain operations and may be configured or arranged in a certain manner. A hardware module can comprise dedicated circuitry or logic that is permanently configured (e.g., as a special-purpose processor, such as a field programmable gate array (FPGA) or an application-specific integrated circuit (ASIC), a digital signal processor (DSP), etc.) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

Upon reading this disclosure, those of skill in the art will appreciate still additional and alternative structural and functional designs for supporting mobility between base stations through the principles disclosed herein. Thus, while particular embodiments and applications have been illustrated and described, it is to be understood that the disclosed embodiments are not limited to the precise construction and components disclosed herein. Various modifications, changes and variations, which will be apparent to those of ordinary skill in the art, may be made in the arrangement, operation and details of the method and apparatus disclosed herein without departing from the spirit and scope defined in the appended claims.

1. A method implemented in a user equipment (UE), the method comprising:
receiving, from a radio access network (RAN) in a serving cell, a measurement configuration for a candidate cell;
receiving, subsequently to the receiving of the measurement configuration and when the measurement configuration is deactivated, an indication of a non-active period in the serving cell; and
in response to the indication of the non-active period, activating the measurement configuration for the candidate cell.

2. The method of claim 1, wherein the activating of the measurement configuration includes:
evaluating the candidate cell using one or more conditions for a conditional handover (CHO).

3. The method of claim 2, further comprising:
executing the CHO in response to determining that an event condEventA4 associated with the candidate cell has occurred.

4. The method of claim 1, any further comprising:
receiving, from the RAN and along with the measurement configuration, an indication that the measurement configuration is deactivated.

5. The method of claim further comprising:
determining, at the UE and upon the receiving of the measurement configuration, that the measurement configuration is deactivated when the candidate cell is associated with a CHO event.

6. The method of claim 5, wherein the CHO event is condEventA4.

7. The method of claim 1, wherein:
the measurement configuration includes a MeasId corresponding to a CHO execution condition.

8. The method of claim 1, wherein:
the measurement configuration is received in a conditionalReconfiguration information element (IE).

9. The method of claim 8, wherein:
the conditionalReconfiguration IE is received in an RRCReconfiguration message.

10. The method of claim 1, wherein:
the indication of the non-active period is received in a system information message broadcast in the serving cell.

11. The method of claim 1, wherein:
the indication of the non-active period is received in a Radio Resource Control (RRC) message.

12. The method of claim 1, wherein the non-active period corresponds to a Network Energy Saving (NES) mode of a base station that operates the serving cell.

13. The method of claim 12, further comprising:
transmitting, from the UE to RAN, an indication that the UE supports the NES mode.

14. The method of claim 13, wherein the indication that the UE supports the NES mode is included in a UEAssistanceInformation message.

15. A method in a base station, the method comprising:
transmitting, to a user equipment (UE) in a serving cell, a measurement configuration for a candidate cell, wherein the measurement configuration is deactivated for the UE;
transmitting, subsequently to the transmitting of the measurement configuration, an indication of a non-active period in the serving cell; and
subsequently to the transmitting of the indication of the non-active period, receiving, from the UE, a measurement report for the candidate cell.

16. An apparatus of a user equipment (UE), the apparatus comprising:
a transceiver; and
processing hardware configured to:
receive, from a radio access network (RAN) in a serving cell, a measurement configuration for a candidate cell;
receive, subsequently to the reception of the measurement configuration and when the measurement configuration is deactivated, an indication of a non-active period in the serving cell; and
in response to the indication of the non-active period, activate the measurement configuration for the candidate cell.

17. The apparatus of claim 16, wherein:
the activation of the measurement configuration includes an evaluation of the candidate cell using one or more conditions for a conditional handover (CHO).

18. The apparatus of claim 16, wherein the processing hardware is further configured to:
execute a conditional handover (CHO) in response to determining that an event condEventA4 associated with the candidate cell has occurred.

19. The apparatus of claim 16, any wherein the processing hardware is further configured to:
receive, from the RAN and along with the measurement configuration, an indication that the measurement configuration is deactivated.

20. The apparatus of claim 16, wherein the processing hardware is further configured to:
determine, upon the reception of the measurement configuration, that the measurement configuration is deactivated when the candidate cell is associated with a CHO event.
